(19) United States
(12) Patent Application Publication
(10) Pub. No.: US 2003/0201589 A1
(43) Pub. Date: Oct. 30, 2003

(54) Bushing with anti-walkout feature

(76) Inventors: Daniel R. Adema, Kitchener (CA); Brent R. Collyer, Wellesley (CA); Christopher W. Forrest, Auburn, IN (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/135,873

(22) Filed: Apr. 30, 2002

(51) Int. Cl. F16F 1/18

(52) U.S. Cl. 267/36.1

(57) ABSTRACT

A bushing is shown to include a barpin having an anti-walkout feature in the form of a flange integrated therewith. The flange extends radially outwardly and circumferentially about the elongated body of the barpin. An elastomer is bonded to the barpin.

### BACKGROUND OF THE INVENTION

The present invention relates to bushings generally, and more specifically, to bushings having anti-walkout features.

Bushings are typically used in a variety of vehicle suspensions. One common use of bushings in vehicle suspensions is to facilitate connection between a vehicle suspension component and another vehicle suspension component, or alternatively, between a vehicle suspension component and the vehicle frame or a frame hanger associated therewith. Conventional bushings used for this purpose typically have three layers. A metal inner component, such as a barpin or thru-bolt, typically forms the first layer. An elastomer typically surrounds the metal inner component, forming the second layer. An outer metal sleeve typically surrounds the elastomer, forming the third layer. Conventional bushings are also referred to as canned bushings by those skilled in the art.

Sleeveless bushings have also been developed. Sleeveless bushings eliminate the outer metal sleeve, i.e., third layer. Sleeveless bushings are also referred to as spool bushings by those skilled in the art. Those skilled in the art will recognize that sleeveless bushings are ordinarily less expensive than conventional three-layer bushings having an outer metal sleeve. Those skilled in the art will further appreciate that sleeveless bushings reduce suspension system weight, which, in the case of commercial vehicles, translates into greater payload capacity.

One recognized problem of bushings is that they have a tendency to walk out of the vehicle suspension component after prolonged use of the suspension. For example, bushings have a tendency to walk out of leaf spring eyes during use. Prior art bushings have incorporated anti-walkout features to reduce the likelihood of walk out.

For purposes of background, FIG. 1 illustrates a vehicle frame 10, a vehicle axle 12 and a vehicle suspension generally designated 14, which suspends frame 10 above axle 12 in a spaced relationship therewith. A frame hanger 16 depends from frame 10 to receive the leaf spring eye portion of a leaf spring 18 positioned at the proximal end of the leaf spring. A bushing 20 is installed within the leaf spring eye portion of leaf spring 18 to facilitate pivotal connection of the leaf spring to frame hanger 16.

An axle clamp assembly 22 clamps axle 12 to vehicle suspension 14, including leaf spring 18. The distal end of leaf spring 18 serves as a mounting surface for an air spring 26, which is connected to frame 10 by way of an air spring mounting bracket 28.

As illustrated in FIG. 1, bushing 20 pivotally connects leaf spring 18 to frame hanger 16. Bushing 20 would have a tendency to walk out of the leaf spring eye during prolonged use of vehicle suspension.

FIG. 2 illustrates a prior art bushing 30 adapted to incorporate anti-walkout features, and a leaf spring eye 32. Bushing 30 includes an inner metal component shown in the form of a barpin 34, an elastomer 36, and an outer metal sleeve 38. The anti-walkout feature of the prior art bushing 30 is a flange 40 formed with outer metal sleeve 38 and extending radially outwardly and circumferentially therefrom. Prior art bushing 30 is installed within leaf spring eye 32. Those skilled in the art will appreciate that flange 40 reduces the likelihood that prior art bushing 30 will walk out of leaf spring eye 32 during use. In particular, flange 40 bears on the spring eye as bushing 30 attempts to walk and thereby retains the bushing within the spring eye. It will be appreciated by those skilled in the art that prior art bushing 30 would be incorporated for use in a vehicle suspension of any type, including but not limited to, vehicle suspension 14 illustrated in FIG. 1.

Prior art bushings incorporating anti-walkout features, such as prior art bushing 30 illustrated in FIG. 2, do not provide anti-walkout control in the event of elastomer degradation. Those skilled in the art will recognize that elastomer degradation is not an unusual result of vehicle suspension use. Additionally, prior art bushings incorporating anti-walkout features, such as prior art bushing 30 illustrated in FIG. 2, do not allow for the use of sleeveless bushings.

The above-noted deficiencies of prior art bushings incorporating anti-walkout features are a result of the anti-walkout feature being integrated with the outer metal sleeve.

In view of the foregoing, it is desirable to develop a bushing that provides anti-walkout control, even in the event of elastomer degradation.

It is further desirable to develop a sleeveless bushing that provides anti-walkout control.

It is further desirable to develop a bushing that integrates an anti-walkout feature with the inner metal component of the bushing.

It is further desirable to develop a bushing that includes an anti-walkout feature in the form of a flange attached to the inner metal component of the bushing.

It is further desirable to develop a bushing that includes an anti-walkout feature in the form of one or more pins that are attached to the inner metal component of the bushing.

These and other desired benefits of the preferred forms of the invention will become apparent from the following description. It will be understood, however, that a device could still appropriate the claimed invention without accomplishing each and every one of these desired benefits, including those gleaned from the following description. The appended claims, not these desired benefits, define the subject matter of the invention. Any and all benefits are derived from the preferred forms of the invention, not necessarily the invention in general.

### BRIEF SUMMARY OF THE INVENTION

The present invention is directed to a bushing having an anti-walkout feature. The bushing includes an inner metal component. The anti-walkout feature is integrated with the inner metal component. An elastomer is bonded to the inner metal component. In one preferred embodiment of the present invention, the anti-walkout feature is a flange. In another preferred embodiment of the present invention the anti-walkout feature is a pin.

The bushing is preferably installed within a leaf spring eye. In the case of the preferred embodiment utilizing a pin as the anti-walkout feature, the leaf spring eye preferably includes an opening extending through it to permit the pin to be press-fit into the inner metal component of the bushing.

### BRIEF DESCRIPTION OF THE SEVERAL VIEWS OF THE DRAWING

Throughout this description, reference has been and will be made to the accompanying views of the drawing wherein like subject matter has like reference numerals, and wherein:

FIG. 1 is a side elevational view of a conventional vehicle frame, vehicle axle and vehicle suspension;

FIG. 2 is an exploded perspective view of a prior art leaf spring eye and a prior art bushing having an anti-walkout feature;

FIG. 3 is a perspective view of a first embodiment of a bushing constructed in accordance with the principles of the present invention;

FIG. 4 is a perspective view of a component of the bushing shown in FIG. 4;

FIG. 5 is a sectional view of the bushing illustrated in FIG. 3, taken along lines 5-5 thereof;

FIG. 6 is an exploded perspective view of a second embodiment of a bushing constructed in accordance with the principles of the present invention, and a leaf spring eye constructed in accordance with the principles of the present invention;

FIG. 7 is a perspective view of part of the bushing shown in FIG. 6; and

FIG. 8 is a sectional view of the bushing illustrated in FIG. 6, taken along lines 8-8 thereof.

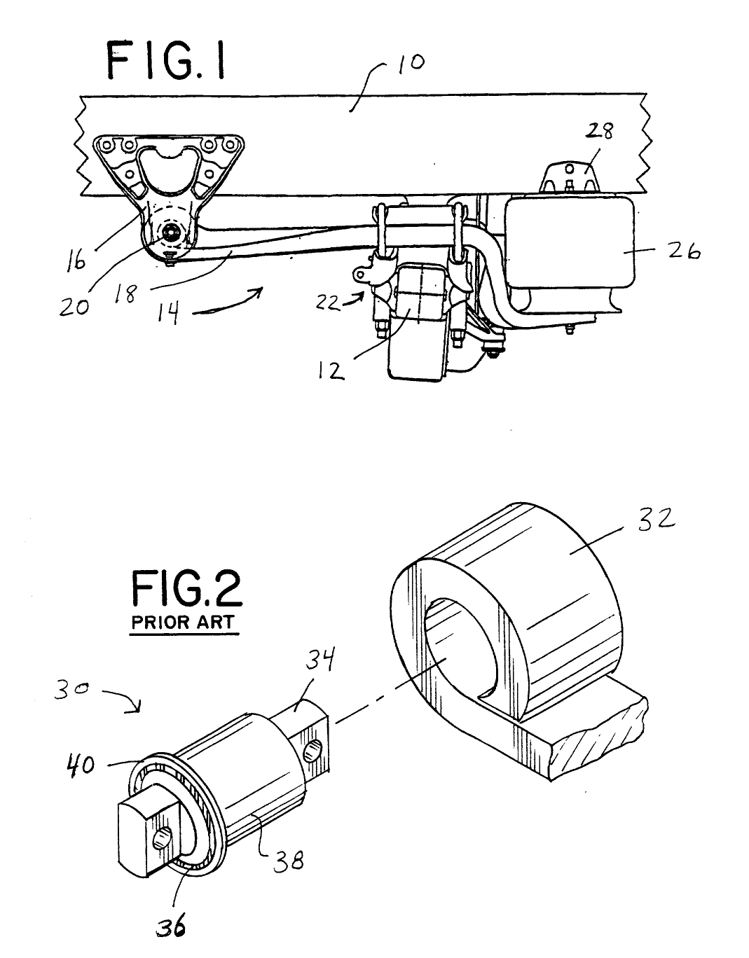

### DETAILED DESCRIPTION OF THE INVENTION

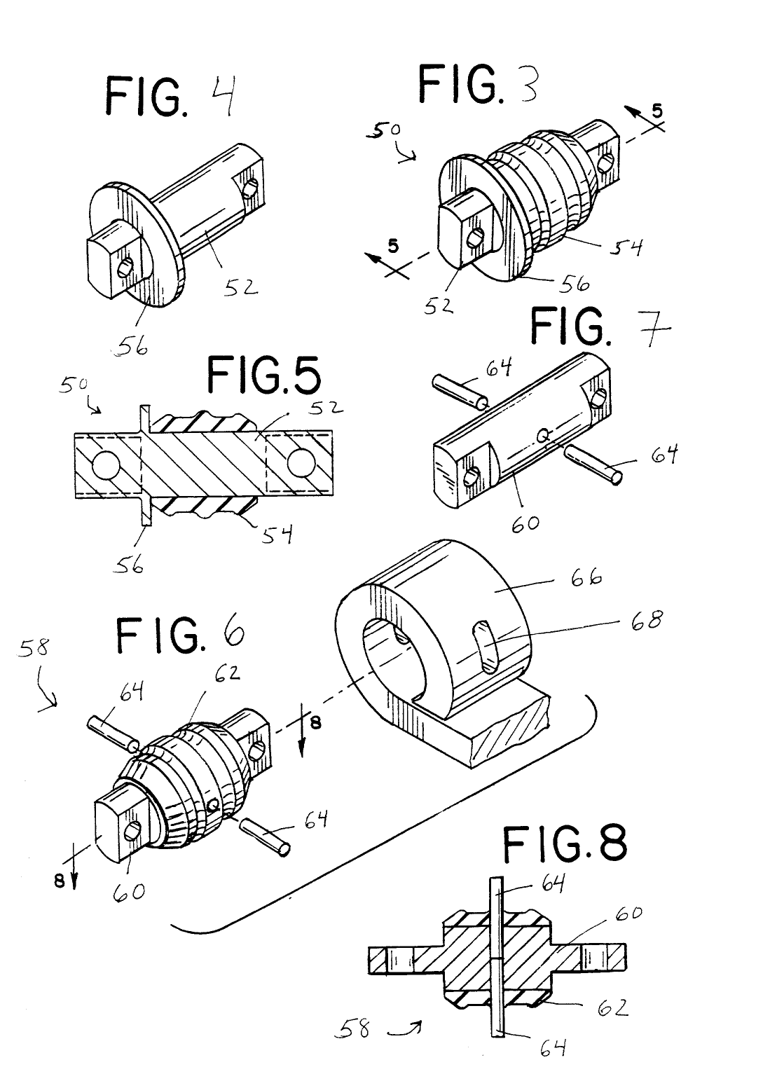

FIGS. 3-5 illustrate a sleeveless bushing 50 having an inner metal component shown in the form of a barpin 52 and an elastomer 54 bonded to the barpin. Bushing 50 includes an anti-walkout feature integrated with barpin 52. In that regard, the anti-walkout feature is a flange 56 attached directly to the inner metal component. Flange 56 extends radially outwardly and circumferentially about the elongated body portion of barpin 52. Flange 56 can be integrated with the inner metal component in a variety of manners. For example, flange 56 can form part of the same casting as the inner metal component. Flange 56 can also be press fit or welded to the inner metal component. Furthermore, flange 56 can be forged with the inner metal component.

Bushing 50 is installed within a leaf spring eye. During use, flange 56 bears on the leaf spring eye as bushing 50 attempts to walk. This helps to retain bushing 50 within the leaf spring eye, and further reduces the likelihood of walk out.

It will be appreciated by those skilled in the art that the addition of an outer metal sleeve to sleeveless bushing 50 would form a traditional three-layer bushing. That construction would still have the anti-walkout feature integrated with the inner metal component of the bushing, and would therefore exhibit the benefits associated therewith.

FIGS. 6-8 illustrate a sleeveless bushing 58 having an inner metal component shown in the form of a barpin 60. Bushing 58 further includes an elastomer 62 bonded to barpin 60. The bushing includes an anti-walkout feature integrated with barpin 60. The anti-walkout feature is shown in the form of one or more pins 64 press fit or otherwise attached directly to barpin 60. In the illustrated embodiment, barpin 60 includes two pins 64 positioned on opposite sides of the elongated body portion of the barpin that extend radially outwardly therefrom. Pins 64 can be press fit into barpin 60 after the bushing is installed within a leaf spring eye 66. In this regard, elastomer 62 and barpin 60 preferably have aligned openings that permit pins 64 to be inserted therein. Additionally, leaf spring eye 66 preferably includes slots or openings 68 that permit insertion of a portion of the pins through them and into bushing 58. In the illustrated preferred embodiment, slots 68 extend radially, circumferentially and axially through the leaf spring eye. A portion of each pin 64 preferably extends radially outside of the inner circumference of the leaf spring eye 66 and into an opening 68. It can also extend through opening 68. Each opening 68 preferably extends axially and circumferentially to an extent to permit normal movement of the bushing during suspension use, but is preferably small enough to prohibit bushing walk out. As a result, the bushing is retained within the leaf spring eye.

It will be appreciated by those skilled in the art that barpin 60 could be used in traditional three-layer bushings having an outer metal sleeve and in sleeveless bushings that do not have an outer metal sleeve. Either construction would still have the anti-walkout feature integrated with the inner metal component of the bushing, and would exhibit the benefits associated therewith. In the case of traditional (canned) bushings, the outer metal sleeve would also preferably have openings to permit pins 64 to be inserted.

While this invention has been described with reference to certain illustrative aspects, it will be understood that this description shall not be construed in a limiting sense. Rather, various changes and modifications can be made to the illustrative embodiments without departing from the true spirit and scope of the invention, as defined by the following claims. Furthermore, it will be appreciated that any such changes and modifications will be recognized by those skilled in the art as an equivalent to one or more elements of the following claims, and shall be covered by such claims to the fullest extent permitted by law.

1. A bushing, comprising:
an inner metal component having an anti-walkout feature integrated therewith; and
an elastomer bonded to said inner metal component.

2. The bushing as defined by claim 1 wherein said anti-walkout feature is a flange.

3. The bushing as defined by claim 1 wherein said anti-walkout feature is part of a common casting with said inner metal component.

4. The bushing as defined by claim 1 wherein said anti-walkout feature is forged with said inner metal component.

5. The bushing as defined by claim 1 wherein said anti-walkout feature is press fitted with said inner metal component.

6. The bushing as defined by claim 1 wherein said anti-walkout feature is welded to said inner metal component.

7. The bushing as defined by claim 1 wherein said anti-walkout feature is a pin.

8. The bushing as defined by claim 7 wherein said pin is press-fitted into said inner metal component.

9. The bushing as defined by claim 1 wherein said inner metal component is a barpin.

10. The bushing as defined by claim 1 wherein said bushing is a sleeveless bushing.

11. A vehicle suspension assembly, comprising:
a leaf spring eye; and
a bushing having an inner metal component with an anti-walkout feature integrated therewith, and further having an elastomer bonded to said inner metal component.

12. The vehicle suspension assembly as defined by claim 11 wherein said anti-walkout feature of said bushing is a flange.

13. The vehicle suspension assembly as defined by claim 11 wherein said anti-walkout feature of said bushing is part of a common casting with said inner metal component.

14. The vehicle suspension assembly as defined by claim 11 wherein said anti-walkout feature of said bushing is forged with said inner metal component.

15. The vehicle suspension assembly as defined by claim 11 wherein said anti-walkout feature of said bushing is press fitted with said inner metal component.

16. The vehicle suspension assembly as defined by claim 11 wherein said anti-walkout feature of said bushing is welded to said inner metal component.

17. The vehicle suspension assembly as defined by claim 11 wherein said anti-walkout feature of said bushing includes a pin, and wherein said leaf spring eye includes an opening extending through it.

18. The vehicle suspension assembly as defined by claim 17 wherein said anti-walkout feature of said bushing includes an additional pin, and wherein said leaf spring eye includes an additional opening extending through it.

19. The vehicle suspension assembly as defined by claim 17 wherein said opening of said leaf spring eye comprises a slot extending circumferentially along said leaf spring eye.

20. The vehicle suspension assembly as defined by claim 17 wherein said pin of said bushing is press-fitted into said inner metal component.

21. The vehicle suspension assembly as defined by claim 11 wherein said inner metal component of said bushing is a barpin.

22. The vehicle suspension assembly as defined by claim 11 wherein said bushing is a sleeveless bushing.
